(19) United States
(12) Patent Application Publication
(10) Pub. No.: US 2011/0113712 A1
(43) Pub. Date: May 19, 2011

(54) PVC Veneer Laminated or Surface Printed Extruded Vinyl Panel With Hollow Channels

(76) Inventor: Benjamin Dengfa Liu, Carmel, IN (US)

(21) Appl. No.: 12/621,082

(22) Filed: Nov. 18, 2009

(51) Int. Cl. E04C 2/38; E04C 2/34; B44F 9/00

(52) U.S. Cl. 52/313; 52/588.1; 52/792.11

(57) ABSTRACT

This invention designed a vinyl panel and panel trim in such ways that hollow channels within the panel (and trims) are connected by thin vinyl walls and two flat surfaces on both side of a panel are formed through the extrusion process. The hollow channels reduce over 80% (depending on the thickness of the wall and surfaces) of vinyl needed for building such a panel in comparison to a solid vinyl panel of same size. The sides of the panel have tongue and groove formed in the extrusion process. The surface(s) of the panel can be further worked on with methods such as laminating patterned (such as wood-grains) PVC veneer, painting, pattern (such as wood-grains) printing, etc. Such panels and trims can be used as wainscot (or wall covering) as a more environmentally-friendly substitute for wood.

### BACKGROUND OF THE INVENTION

Traditional wainscot or wall covering panels are made of wood or MDF. People begin to use solid vinyl panel in this application in a damp or wet places such as bathrooms. The cost of solid vinyl panel is higher than that of MDF or wood panels. Because wainscot panels are used mainly for decoration purposes, they don't need to have high strength. This invention designs wainscot panels in such a way that hollow channels are incorporated into the interior bodies of the panels, thus reducing the amount of vinyl material used. Panel trims are also designed with interior hollow channels. The advantages of the invented panels are as follows:
(a) The invented vinyl panel with hollow channels uses less than 80% of vinyl in comparison to the solid vinyl panel of same size.
(b) The invented vinyl panel with hollow channels costs less than that of wood and MDF. This product is a good substitute for wood based panels.
(c) The invented vinyl panel is to be pre-finished with either PVC veneer lamination or surface printed with wood grain or other patterns.
(d) The invented vinyl panel is suitable to be used in a damp or wet area.

### SUMMARY OF THE INVENTION

This invention designed a vinyl panel and panel trim in such ways that hollow channels within the panel (and trims) are connected by thin vinyl walls and two flat surfaces on both side of a panel are formed through the extrusion process. The hollow channels reduce over 80% (depending on the thickness of the wall and surfaces) of vinyl needed for building such a panel in comparison to a solid vinyl panel of same size. The sides of the panel have tongue and groove formed in the extrusion process. The surface(s) of the panel can be further worked on with methods such as laminating a wood-grain PVC veneer, painting, wood-grain printing, etc. Such panels and trims can be used as wainscot (or wall covering) as a more environmentally-friendly substitute for wood.

### BRIEF DESCRIPTION OF THE DRAWINGS OF THE INVENTION

FIG. 1 shows panel cross-sections as examples.

FIG. 2 shows three dimensional illustration of the invented vinyl panel with a flat surface.

FIG. 3 shows three dimensional illustration of the invented vinyl panel with square penal lines.

FIG. 4 shows three dimensional illustration of the invented vinyl panel with two-half-circle panel lines.

FIG. 5 shows panel trim design illustration.

FIG. 6 shows an illustration of tongue and groove jointed panels.

FIG. 7 shows an illustration of tongue and groove jointed panels with panel trims.

### DETAILED DESCRIPTION OF THE INVENTION

1. The Physical Structure

The invented dual toilet flush system consists of units (or modules) as follows:

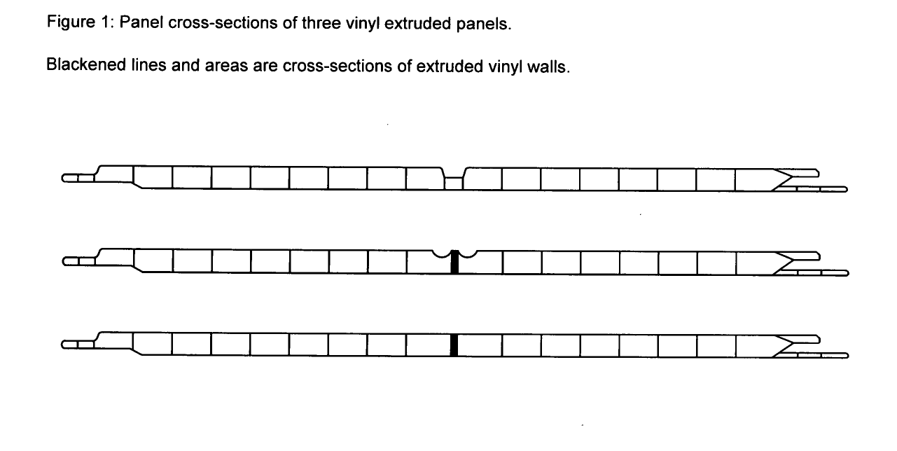

(a) Top surface (FIG. 1)
Top surface is the surface that will be exposed after panel installation (it can also be called utility surface). The profiles and patterns (either veneered or printed on) are for the purpose of decoration.

(b) Bottom surface (FIG. 1)
Bottom surface provides the support and a flat surface for installation against walls.

(c) Hollow channels (FIG. 1)
Hollow channels inside penal cut the vinyl materials needed to build such a panel.

(d) Tongue (FIG. 1)
Tongue is a designed male part of a whole joint for connecting two or more panels width-wise.

(e) Groove (FIG. 1, 6,7)
Groove is a designed female part of a whole joint for connecting two or more panels width-wise.

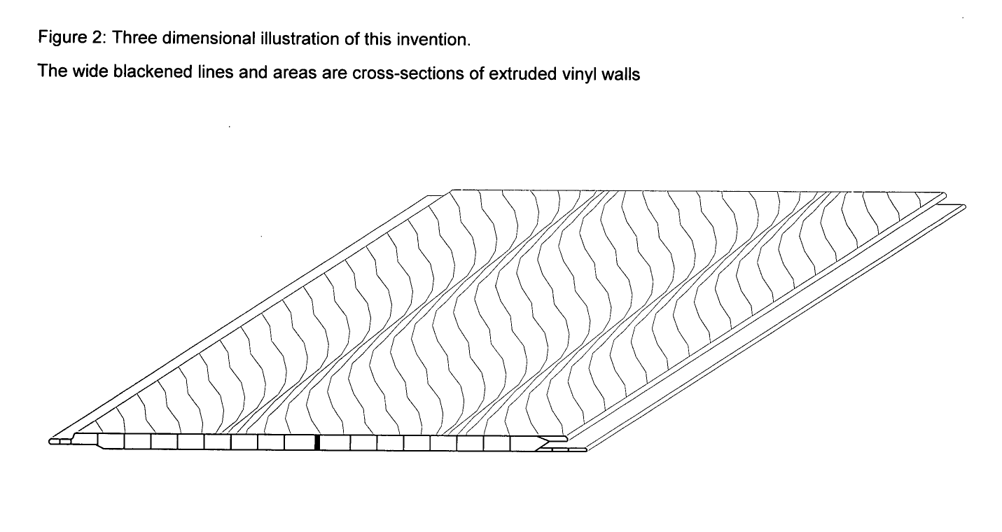

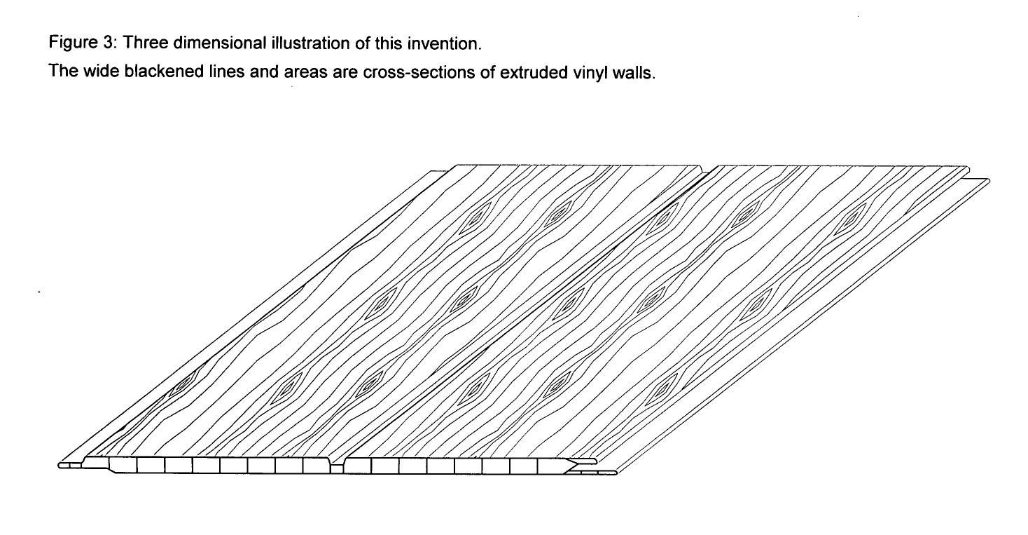

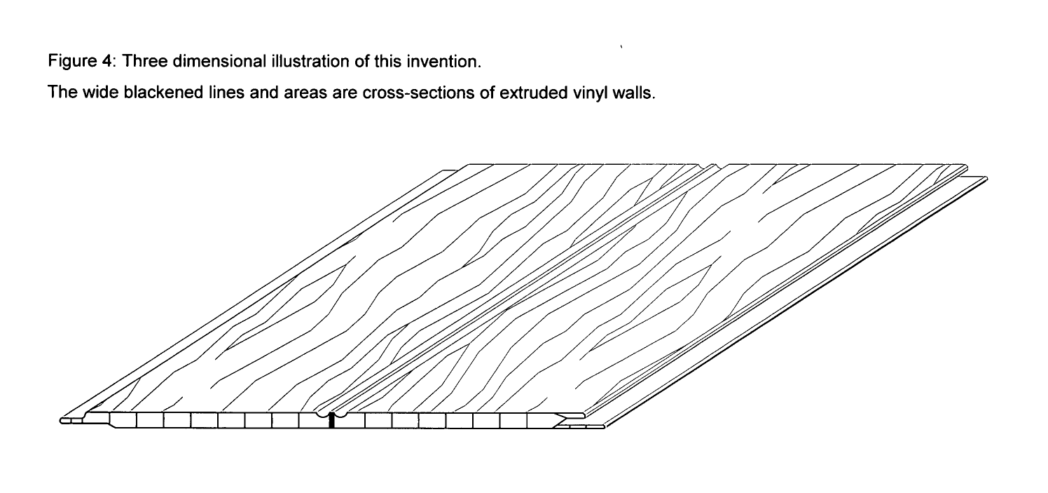

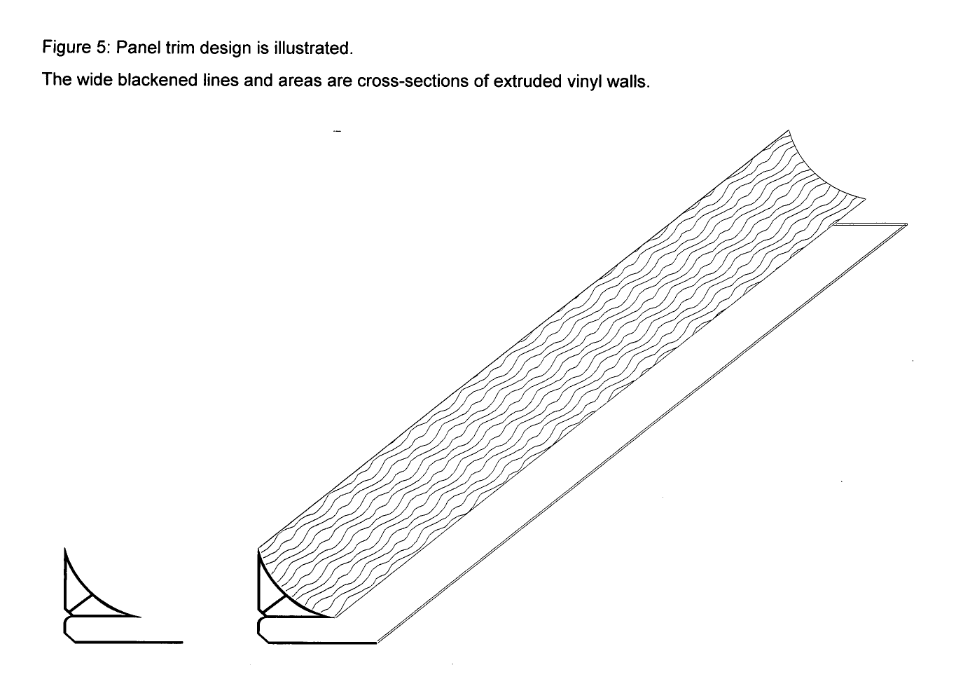

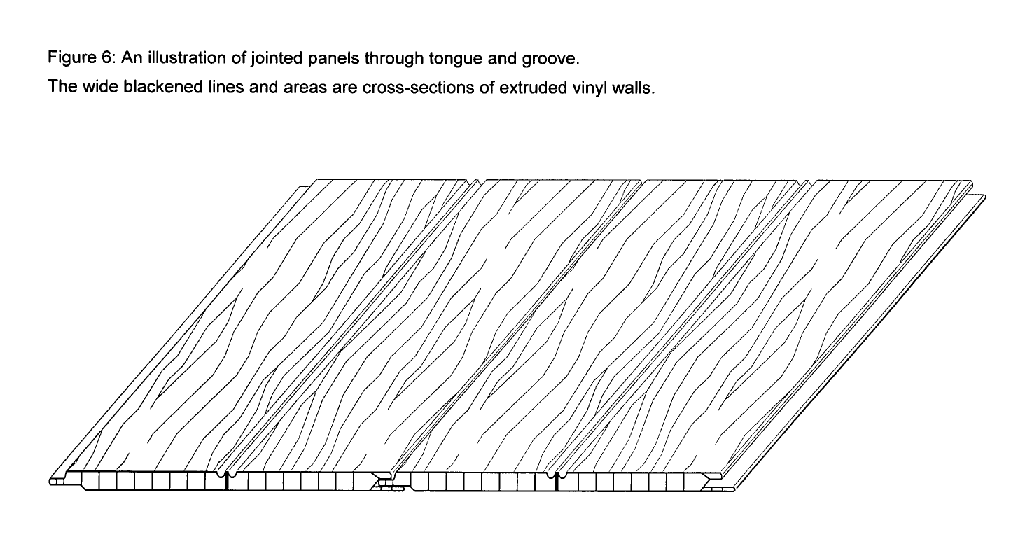

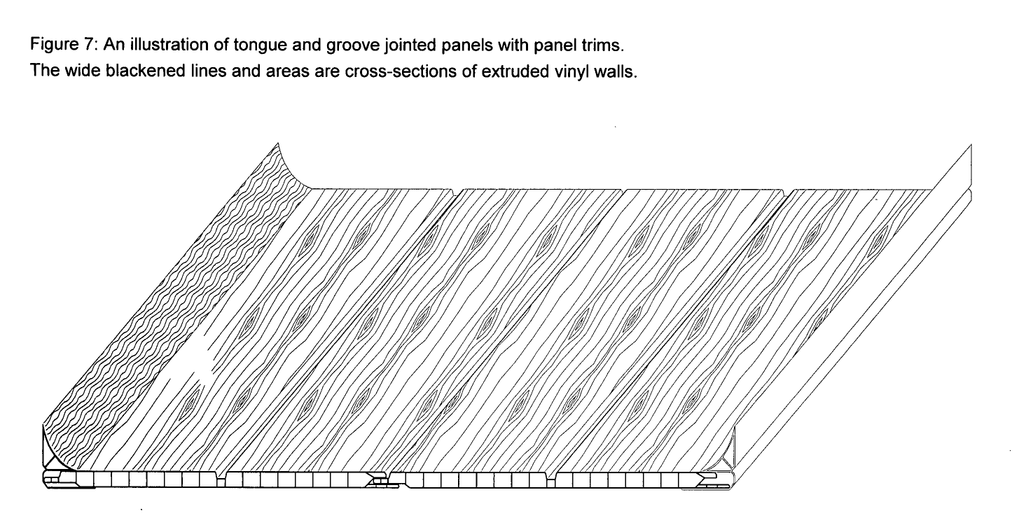

(f) PVC veneer lamination (FIG. 2-7)
PVC veneer lamination is a way to finish the panel surface with any patterns such as wood grains, marble grains, pictures, etc.

(g) Surface printing (FIG. 2-7)
Surface printing is a way to finish the panel surface with any patterns such as wood grains, marble grains, pictures, etc.

2. Operation of the Invented Panel

(a) The invented wainscot panels are used for a wall (or a flat surface with a strong solid backing) covering and decoration.

(b) Cutting the panel to the appropriate length so that the total length of the panel and trims' thickness (a trim at the bottom and a trim at the top) are the same as the height of the area.

(c) The width of the area divided by the width of the panel (the top surface width) gives the number of pieces needed to cover the whole area. A panel can be cut with a regular wood saw.

(d) Each panel must be glued-down or nailed down at the hidden area of tongue and grooves.

(e) The panels are placed next to each other by tongue and groove jointing.

(f) Penal trims are installed around the installed panels to cover up the ends and sides.

### Cross-References for the Invention of Veneer Laminated or Surface Printed Extruded Vinyl Panels with Interior Hollow Channels

There are no other patents that are close or similar to this invention from the US Patent search by this inventor. However, there are a few patents exist for vinyl extrusion as follows:

7,507,464 is for extruded variegated plastic siding panels

6,733,870 is for extrusion coating process for making protective and decorative films

5,662,977 is process for manufacturing plastic siding panels with outdoor weatherable embossed surfaces

5,224,318 is for Molded protective exterior weather-resistant building panels

1. This invention designed a vinyl panel in such ways that hollow channels within the panel are connected by thin vinyl walls and two flat surfaces on both sides of a panel are formed through the extrusion process. The hollow channels occupy majority of the panel cross-section.

2. According to claim 1, the thicknesses of the walls between these hollow channels (interior walls), and of the upper and lower surfaces of the panel can be different. The upper surface of the panel is usually thicker as an exposed (utility) surface. On the other hand, the lower surface of the panel and interior walls are thinner.

3. According to claim 2, the exposed surface can be designed with different profiles and panel line profiles.

4. According to claim 1-3, a tongue (male side of the joint) on one side of the panel and a groove (female side of the joint) are formed in the extrusion process.

5. According to claim 4, the panels are readily to expand in width through tongue and groove jointing of two or more panels together.

6. According to claim 1-5, the surface(s) of the panel can be further worked on with methods such as laminating a patterned (such as wood-grain or marble, etc.) PVC veneer, painting, pattern (wood-grain, or other) printing, etc. Such panels can be used as wainscot (or wall covering) as a more environmentally-friendly substitute for wood wainscot.

7. According to claim 6, the patterns of PVC veneer and printed patterns can be wood-grains of various wood species, marble grains of various stones, pictures, etc.

8. According to claims 1-7, the invented panels can be used as substitutes for wood and MDF wainscot panels.

9. According to claims 1-8, panel trims are designed and made the same way as the panel.
